(19) United States
(12) Patent Application Publication
(10) Pub. No.: US 2018/0357689 A1
(43) Pub. Date: Dec. 13, 2018

(54) System to provide requirements within a region and a method thereof

(71) Applicant: Zeroplus Technology Co., Ltd., New Taipei City (TW)

(72) Inventors: CHIU-HAO CHENG, NEW TAIPEI CITY (TW); TIEN-YU WU, NEW TAIPEI CITY (TW)

(21) Appl. No.: 15/621,499

(22) Filed: Jun. 13, 2017

(51) Int. Cl. G06Q 30/06; G06Q 20/36; H04W 4/02; H04L 29/08

(52) U.S. Cl. CPC G06Q 30/0605; G06Q 20/3672; G06Q 40/04; H04L 67/18; G06Q 30/0639; H04W 4/026

(57) ABSTRACT

A system to provide requirements within a region and a method thereof feature the system comprises a server platform and an application program installed on a user's intelligent communications device. The application program is sued to create demanded task items which are uploaded to the server platform, published within a specific coverage referring to coordinate information, and read by at least a supply side within the coverage; the supply side who received and completed demand content in the demanded task items can republish the demand content, the total number of required supply sides, and a user ID of the supply side having completed a task within a specific coverage referring to coordinate information of the supply side for any opening of the task. As such, the demand content of a first supply side will be received and processed by users at different positions and a user has dual identities of a demand side and a supply side through the system and the method in the present disclosure.

### BACKGROUND OF THE INVENTION

### 1. Field of the Invention

The present disclosure relates to a system to provide requirements within a region and a method thereof, particularly a system to fulfill a task through interactive mutual assistance within a specific coverage and a method thereof through which a user has dual identities of a demand side and a supply side.

### 2. Descriptions of the Related Art

Currently, smart phones in the era of technologies developed dramatically become one part of people's lives and have been popularized and multi-functionalized such that more and more users depend on functions of smart phones to surf the Internet, photograph, listen music, watch videos and share information.

Amid Internet users' requests to be satisfied, the transactions through online auction websites on which users post messages of auctions are not successful until consumers' orders for auction items are placed. In this regard, a seller even waits for quite a while and receives the reply of a buyer, who intends to buy something and selects a favorite product among numerous options presented in an online auction website. Moreover, the delivery of a sold product perplexes a consumer who is starved of something due to a long distance between a seller and a buyer.

Accordingly, the transaction mechanism which falls short of immediacy and convenience is not good enough because either a buyer or a seller probably wait for a long time for completion of a transaction.

Against this background, a system to provide requirements within a region and a method thereof should be a technical solution in which a published task related to the demand content of a first supply side can be received and processed by users at different positions for fulfillment of the task by at least one user, who stays at a distinct location and within an identical coverage referring to another user's coordinate information, through users' interactive mutual assistances.

### SUMMARY OF THE INVENTION

The present disclosure relates to a system of fulfilling a task through interactive mutual assistance within a specific coverage and a method thereof

A system to provide requirements within a region in the present disclosure comprises: a server platform, used to regulate running of the whole system through which requirements are provided within a region, manage more than one available token related to a user ID, and add/deduct the token related to the user who is a demand side or a supply side according to the user's behavior; an application program, connected to the server platform, installed in a user's intelligent communications device with at least a GPS module, and comprising an operator interface module in which several operator interfaces for running of the application program by a user are embedded; a task publishing module, connected to the operator interface module, the GPS module, and the server platform for creation of demanded task items, which comprise a user ID of at least a first demand side, demand content, the total number of required supply sides, a default distance between a supply side and a demand side, and coordinate information, uploading the demanded task items to the server platform from which the user ID of the first demand side, the demand content, and the total number of required supply sides are sent to all intelligent communications devices using the application program within the default distance wherein the server platform can add or deduct an available token for the user ID of the first demand side according to the total number of required supply sides; a task-receiving acknowledgement module, which is connected to the operator interface module for reconfirming acceptation of the demand content of the demanded task items with the user ID, the demand content and the total number of required supply sides from the server platform received; a real-time communications module, which is connected to the operator interface module, the task-receiving acknowledgement module, and the server platform for real-time communications between a user and another user through the server platform; a task-fulfilling acknowledgement module, which is connected to the operator interface module and the task-receiving acknowledgement module and used to send a notification to the server platform for addition of an available token related to a user ID of a supply side who fulfilled a task with the demand content of the demanded task items completed; an task assistance publishing module, which is connected to the operator interface module, the task-fulfilling acknowledgement module, the GPS module, and the server platform wherein a supply side having fulfilled a task for completion of the demand content of the demanded task items is able to link the server platform through the task assistance publishing module and resend the demand content, the total number of required supply sides, and the user ID of the supply side to intelligent communications devices using the application program for continuously republishing any opening of required supply sides in the task within a specific coverage related to coordinate information of the supply side; accordingly, the task assistance publishing module allows the demand content of demanded task items published by a first demand side to be received and processed by at least a user who stays at a distinct location and within a specific coverage related to another user's coordinate information.

Specifically, the real-time communications module is used in voice, text or video communications.

Specifically, the demand content relates to products or services.

Specifically, the intelligent communications device is a smart phone, a PDA or a PAD.

Specifically, the real-time communications module will ask a single user, who stays outside a specific coverage related to coordinate information of another user with whom the single user communicates, or both the users communicating with each other for continuing communications.

A method of a system to provide requirements within a region, comprising steps as follows:
(1) A request for providing requirements in which a default distance between a supply side and a demand side is defined by the demand side is received through an application program;
(2) An object in the request for providing requirements is given to the demand side by the supply side who agreed and received the request; and
(3) A token for completion of the request for providing requirements is created and assigned to the supply side.

Specifically, the demand side who owns at least one token is qualified to publish a request for providing requirements wherein the token will be deducted with one corresponding request for providing requirements made.

Specifically, a first supply side having completed a previous request for providing requirements, which should be completed by at least two supply sides, can be transformed to a demand side and support an initial demand side to complete the request.

Specifically, the published request for providing requirements, that is, the demand content of a first demand side, can be received and processed by users who are distributed at distinct positions and serve as supply sides, at least one of whom stays within a default distance from another demand side.

Specifically, the request for providing requirements comprises at least a user ID, demand content, the total number of required supply sides, and coordinate information and is created by a demand side and uploaded to a server platform from which the user ID, the demand content, the total number of required supply sides, and the coordinate information are published within a default distance.

Specifically, the request for providing requirements cannot be published continuously if there is no opening of required supply sides in a task.

Specifically, the demand content relates to products or services.

Specifically, the supply side and the demand side are able to communicate with each other immediately through voice, text or video communications.

Specifically, the supply side and/or the demand side, each of whom stays outside a default distance from the other one during real-time communications, will be asked for continuing the communications.

### BRIEF DESCRIPTION OF THE DRAWINGS

FIG. 1 is a schematic view for overall architecture of a system to provide requirements within a region and a method thereof.

FIG. 2 is a schematic view for architecture of an application program in a system to provide requirements within a region and a method thereof.

FIG. 3A is a schematic view which illustrates a system to provide requirements within a region and a method thereof in the first embodiment.

FIG. 3B is a schematic view which illustrates a system to provide requirements within a region and a method thereof in the first embodiment.

FIG. 4A is a schematic view which illustrates a system to provide requirements within a region and a method thereof in the second embodiment.

FIG. 4B is a schematic view which illustrates a system to provide requirements within a region and a method thereof in the second embodiment.

FIG. 5 is a schematic view which illustrates a system to provide requirements within a region and a method thereof in the third embodiment.

FIG. 6 is a flow chart for application of a system to provide requirements within a region and a method thereof.

### DETAILED DESCRIPTION OF THE PREFERRED EMBODIMENTS

The technical content, features and effects of a system to provide requirements within a region and a method thereof in the present disclosure are clearly explained in preferred embodiments and accompanying drawings.

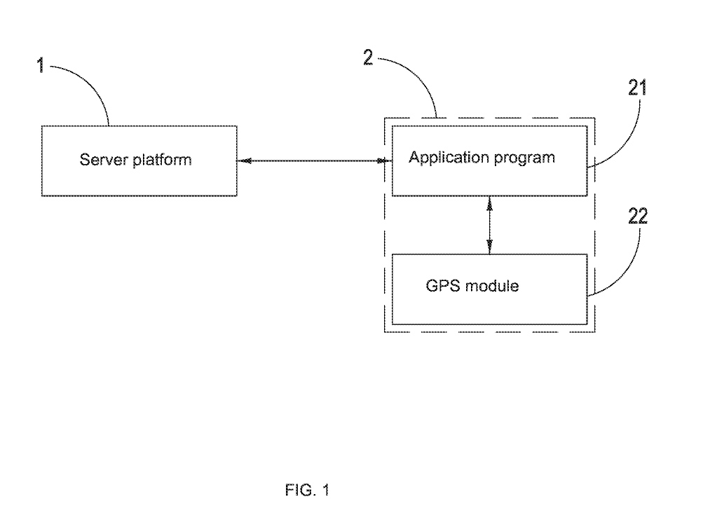

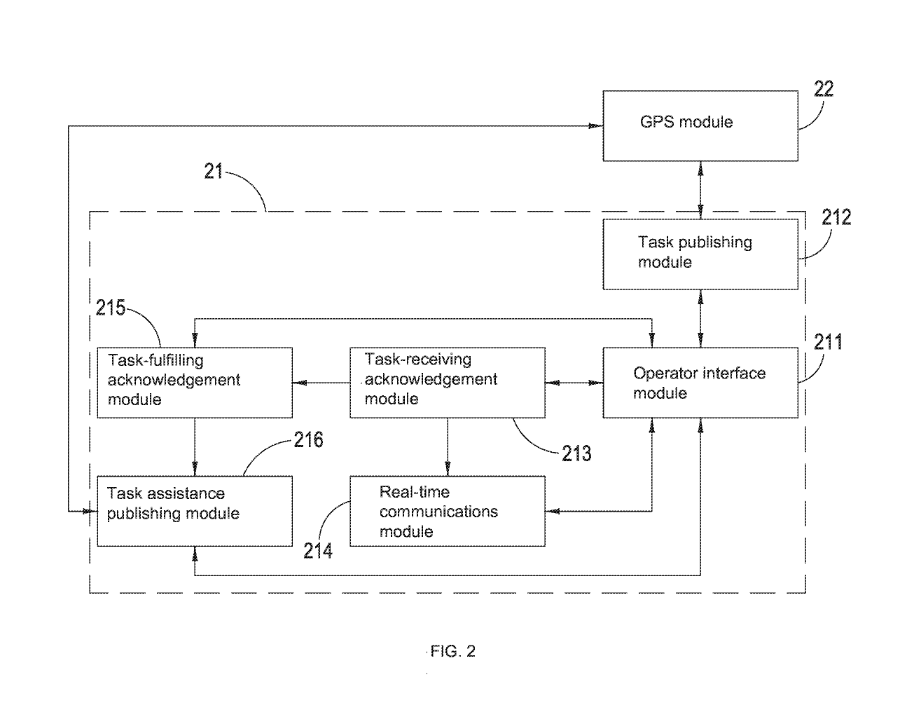

Referring to FIGS. 1 and 2, which are a schematic view for overall architecture of a system to provide requirements within a region and a method thereof as well as a schematic view for architecture of an application program, respectively; as shown in FIGS. 1 and 2, a system to provide requirements within a region comprises a server platform 1 and an application program 21 wherein the server platform 1 is used to regulate running of the whole system, manage more than one available token of a user ID, and add/deduct the token (for example, bonus point as data to be added or deducted) based on behavior of a user (a demand side or a supply side).

The application program 21 is installed in a user's intelligent communications device 2 on which at least a GPS module 22 is mounted for connections of several application programs 21 to the server platform 1; the application program 21 comprises an operator interface module 211, a task publishing module 212, a task-receiving acknowledgement module 213, a real-time communications module 214, a task-fulfilling acknowledgement module 215 and an task assistance publishing module 216 wherein the operator interface module 211 provides a user with an operator interface through which the application program 2 is run by the user.

The task publishing module 212 is used to create demanded task items which comprise a user ID of at least a first supply side, demand content (needed product, product to be sold, a default distance between a supply side and a demand side, service to be offered, or needed service in provided requirements), the total number of required supply sides, and coordinate information; the task publishing module 212 uploads the demanded task items to the server platform 1 from which the demanded task items, that is, the user ID of the first supply side, the demand content and the total number of required supply sides are sent to an intelligent communications device 2 using the application program 21 within the default distance; the server platform 1 deducts the available token (for example, bonus point) for the user ID of the first supply side according to the total number of required supply sides.

The demand content published from the server platform 1 can be read through an online application program 21 within a specific coverage referring to coordinate information of a demand side (a task publisher). When the user ID, the demand content and the total number of required supply sides published from the server platform 1 are received by the task-receiving acknowledgement module 213, each of other supply sides, who checks and prefers to accept a published task through the application program 21, is able to reconfirm and receive the demand content of the demanded task items by means of the task-receiving acknowledgement module 213.

A supply side reading the published task communicates with the demand side from whom the task was published through the real-time communications module 214 immediately (according to voice, text, or video communications) for reconfirming the task prior to determination of accepting the task.

A supply side sends a notification to the server platform 1 that the demand content of the demanded task items was received and completed through the task-fulfilling acknowledgement module 215 in order to add one more available token in the server platform 1 for the user ID of the supply side; the notification can be sent by a demand side from whom the task was published or a supply side who received and completed the task according to configurations.

A supply side, who has completed a task, links the server platform 1 through the task assistance publishing module 216 and republishes the demand content, the total number of required supply sides, and the user ID of the supply side (having completed the task but probably changing his/her role as a demand side) to an intelligent communications device 2 using the application program 21 within a specific coverage referring to coordinate information of the supply side for any opening of supply sides required in the task; however, as the last one who completed the task, the supply side cannot continue republishing the task due to no opening of the supply sides (the total number of required supply sides=0).

Accordingly, the demand content of the demanded task items which were published from the first supply side is received and processed by at least another supply side at a distinct location and within the same default distance as a demand side through the task assistance publishing module 216.

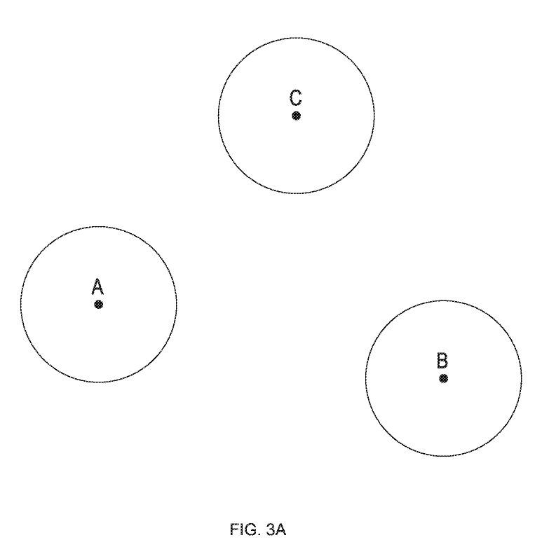

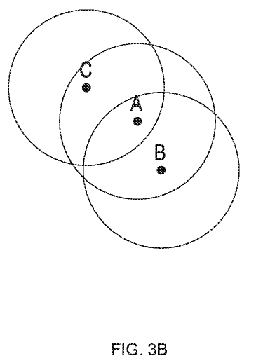

FIGS. 3A and 3B illustrate user A (a demand side at a central point, which is the current location of user A and the center of a circle for development of the coverage of a task published from a user's application program), user B, and user C in the first embodiment. In the first embodiment, user A is the first task publisher and a task has the demand content of “5 movie tickets” and “4 supply sides” required totally (for deduction of 5 points, available tokens in a published task). As shown in FIG. 3B, information such as user ID, demand content and total number of required supply sides are read by user B (at a circle's central point) and user C (at another circle's central point), both of whom are supply sides moving into the acceptable coverage of a task published by user A.

User B or user C, each of whom reads published information such as user ID, demand content and total number of required supply sides, communicates with user A immediately according to the published user ID (through voice, text, or video communications) for completion of a task, that is, a face-to-face transaction of a movie ticket after mutual consent between user A and user B (or user C). With the transaction (the task of user B or user C) completed, a notification will be sent to the server platform 1 by user A for addition of one more token of user B or user C.

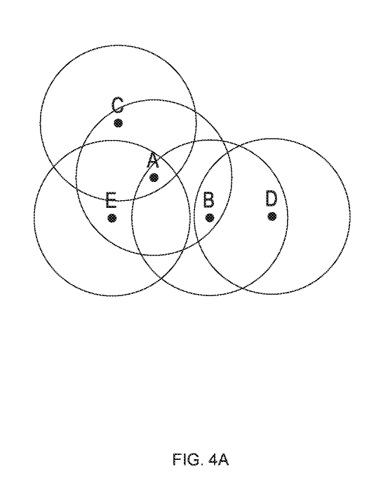

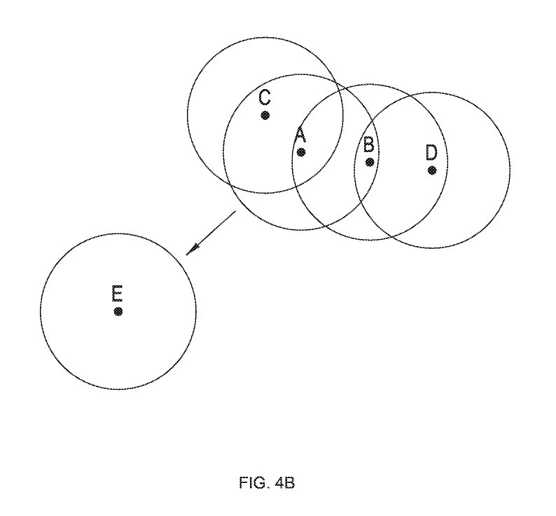

As shown in FIGS. 4A and 4B for the second embodiment, a task can be continuously published by a supply side, user B (or user C), who completed the task, at his/her discretion. If user C has no intention to publish the task continuously, user B (who serves as a supply side from a demand side originally) keeps the task published. When user D walks into the coverage of the task published by user B (the coverage is determined according to a default distance between a supply side and a demand side defined by the first task publisher or changed by user B who redefines the default distance between a supply side and a demand side), user D can read information published by user B such as user ID (user IDs of user B and even user A by configurations), demand content (5 movie tickets) and total number of required supply sides (4).

User D, who read published information such as user ID, demand content and total number of required supply sides, communicates with user B (or user A) immediately according to the published user ID(s) (through voice, text, or video communications) for completion of the task, that is, a face-to-face transaction of a movie ticket after mutual consent between user D and user A. With the transaction (the task of user D) completed, a notification will be sent to the server platform 1 by user D for addition of one more token of user D.

Furthermore, user E, who walks into the coverage of the task published by user A, reads published information such as user ID, demand content (5 movie tickets) and total number of required supply sides (4). In the course of real-time communications between user E and user A, user A and/or user E, who stays outside the coverage of the task published by user A, may be asked for communicating with each other continuously. Moreover, user A and user E, who stayed outside the coverage of the task published by user A but disconnected real-time communications with user A after having read information published by user A, may be asked for communicating with each other continuously.

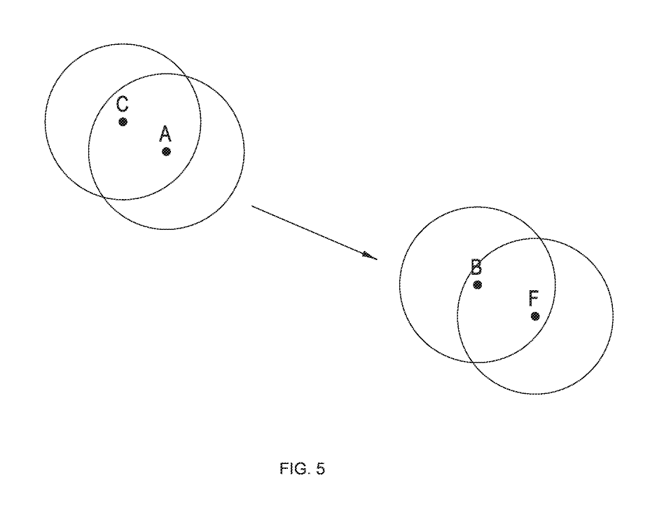

FIG. 5 illustrates the third embodiment that user B, who serves as a supply side from a demand side originally, stays outside the coverage of the task published by user A and has intention of and is qualified for keeping the task published. Then, user F, who walks into the coverage of the task published by user B, reads information such as user ID (user IDs of user B and even user A by configurations), demand content (5 movie tickets) and total number of required supply sides (4).

When user F has intention to receive the task, user B sends a notification to the server platform 1. However, user F cannot serve as a supply side of the task, which was received and completed by user B, user C, user D and user E. The server platform 1 will inform user F of no task available due to no opening of a supply side.

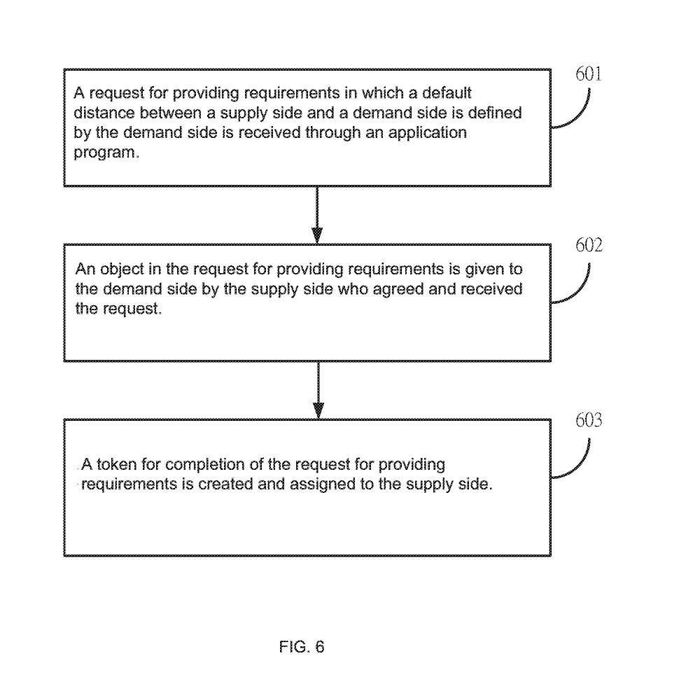

A method of a system to provide requirements within a region as shown in FIG. 6 comprises steps as follows:
(1) A request for providing requirements in which a default distance between a supply side and a demand side is defined by the demand side is received through an application program 601;
(2) An object in the request for providing requirements is given to the demand side by the supply side who agreed and received the request 602; and
(3) A token for completion of the request for providing requirements is created and assigned to the supply side 603.

In a method of a system to provide requirements within a region, a supply side having read the demanded task items published within the default distance (defined as the radius of a circle with the center at which coordinate information of a demand side is located) can opt for receiving the demand content of the demanded task items and communicating with the demand side (also the task publisher) immediately. The supply side having completed the demand content of the demanded task items can opt for continuing publishing of the task for any opening of required supply sides; if the task is to be published continuously, the demand content, the total number of required supply sides, and the user ID of the supply side are rebroadcasted through the server platform within a specific coverage relating to coordinate information of the supply side for completion of the original demand content.

Moreover, the real-time communications module 214 features the function of supportive purchasing/booking and the function of matching supportive purchasing/booking for transactions within a specific region (coverage) based on a system to provide requirements within a region and a method thereof in the present disclosure; according to a product or service list, products or services are available to a buyer within a specific coverage, which is regionally configured in the application program by a buyer or a retailer.

There is an example hereinafter to illustrate that a GPS module 22 in the intelligent communications device 2 is activated by a buyer, who intends to search retailers or services within a specific coverage, for configuring transaction conditions (for example, retailers within a specific coverage and retailers' services) wherein the specific coverage can be configured as x meter, y kilometer and z mile optionally.

The retailers in a preset coverage are displayed through the application program 21 of a buyer's intelligent communications device 2 and browsed and checked by the buyer. Furthermore, to make a reservation or order food as required in advance, the buyer may check current business status of a retailer, for example, the number of diners, free tables, waiting diners and booking for a restaurant, and read any processing result delivered through the real-time communications module 214.

Additionally, a region in which a buyer moves can be extended properly according to a buyer's and a seller's requirements. For example, a buyer leaves for a retailer to purchase promotional products for group buying within a preset region but the discount privilege is not available because of fewer products to be purchased by the buyer; however, the buyer may publish the retailer's latest offer for group buying within his/her moving area, with permission of the retailer.

It should be mentioned that a buyer who has stayed outside a preset region configured by a retailer still continues advertising his/her favorite products to solicit more shoppers with the same hobby for group-buying discount. On the other hand, the buyer may act as a purchasing agent by informing members in a friend list of purchasing favorite products through the real-time communications module 214 for a fast effect of group buying.

In contrast to other conventional techniques, a system to provide requirements within a region and a method thereof in the present disclosure features advantages as follows:
(4) A task will be fulfilled by participants within a specific coverage through interactive mutual assistance, that is, a published task with the demand content of a first supply side is received and processed by at least a user who stays at a distinct location and within another user's coverage for coordinate information.
(5) A user who plays a reliever of another online user can be quickly found within a specific coverage based on techniques in the present disclosure which can be well performed in a community or a small group of people particularly.
(6) A user who provides other people with demanded content or asks other people to fulfill a personal request may have dual identities of a demand side and a supply side.

The preferred embodiments hereof should not be taken as examples to restrict the scope of a system to provide requirements within a region and a method thereof in the present disclosure. The partial changes and modifications made by the skilled persons who familiarizes themselves with the above technical features and embodiments without departing from the spirit and scope of the present disclosure should be covered in claims of the patent specification.

What is claimed is:

1. A system to provide requirements within a region, comprising:
a server platform, used to regulate running of the whole system through which requirements are provided within a region, manage more than one available token related to a user ID, and add/deduct the token related to the user who is a demand side or a supply side according to the user's behavior;
an application program, connected to the server platform, installed in a user's intelligent communications device with at least a GPS module, and comprising:
an operator interface module in which several operator interfaces for running of the application program by a user are embedded;
a task publishing module, connected to the operator interface module, the GPS module, and the server platform for creation of demanded task items, which comprise a user ID of at least a first demand side, demand content, the total number of required supply sides, a default distance between a supply side and a demand side, and coordinate information, uploading the demanded task items to the server platform from which the user ID of the first demand side, the demand content, and the total number of required supply sides are sent to all intelligent communications devices using the application program within the default distance wherein the server platform can add or deduct an available token for the user ID of the first demand side according to the total number of required supply sides;
a task-receiving acknowledgement module, which is connected to the operator interface module for reconfirming acceptation of the demand content of the demanded task items with the user ID, the demand content and the total number of required supply sides from the server platform received;
a real-time communications module, which is connected to the operator interface module, the task-receiving acknowledgement module and the server platform for real-time communications between a user and another user through the server platform;
a task-fulfilling acknowledgement module, which is connected to the operator interface module and the task-receiving acknowledgement module and used to send a notification to the server platform for addition of an available token related to a user ID of a supply side who fulfilled a task with the demand content of the demanded task items completed;
a task assistance publishing module, which is connected to the operator interface module, the task-fulfilling acknowledgement module, the GPS module, and the server platform wherein a supply side having fulfilled a task for completion of the demand content of the demanded task items is able to link the server platform through the task assistance publishing module and resend the demand content, the total number of required supply sides, and the user ID of the supply side to intelligent communications devices using the application program for continuously republishing any opening of required supply sides in the task within a specific coverage related to coordinate information of the supply side;
accordingly, the task assistance publishing module allows the demand content of demanded task items published by a first demand side to be received and processed by at least a user who stays at a distinct location and within a specific coverage related to another user's coordinate information.

2. A system to provide requirements within a region as claimed in claim 1 wherein the real-time communications module is used in voice, text or video communications.

3. A system to provide requirements within a region as claimed in claim 1 wherein the demand content relates to products or services.

4. A system to provide requirements within a region as claimed in claim 1 wherein the intelligent communications device is a smart phone, a PDA or a PAD.

5. A system to provide requirements within a region as claimed in claim 1 wherein the real-time communications module will ask a single user, who stays outside a specific coverage related to coordinate information of another user with whom the single user communicates, or both the users communicating with each other for continuing communications.

6. A method of a system to provide requirements within a region, comprising steps as follows:
a request for providing requirements in which a default distance between a supply side and a demand side is defined by the demand side is received through an application program;
an object in the request for providing requirements is given to the demand side by the supply side who agreed and received the request; and
a token for completion of the request for providing requirements is created and assigned to the supply side.

7. A method of a system to provide requirements within a region as claimed in claim 6 wherein the demand side who owns at least one token is qualified to publish a request for providing requirements and the token will be deducted with one corresponding request for providing requirements made.

8. A method of a system to provide requirements within a region as claimed in claim 6 wherein a first supply side completing a previous request for providing requirements, which should be completed by at least two supply sides, can be transformed to a demand side and support an initial demand side to complete the request.

9. A method of a system to provide requirements within a region as claimed in claim 8 wherein the published request for providing requirements, that is, the demand content of a first demand side, can be received and processed by users who are distributed at distinct positions and serve as supply sides, at least one of whom stays within a default distance from another demand side.

10. A method of a system to provide requirements within a region as claimed in claim 8 wherein the request for providing requirements comprises at least a user ID, demand content, the total number of required supply sides and coordinate information and is created by a demand side and uploaded to a server platform from which the user ID, the demand content, the total number of required supply sides, and the coordinate information are published within a default distance.

11. A method of a system to provide requirements within a region as claimed in claim 10 wherein the request for providing requirements cannot be published continuously if there is no opening of required supply sides in a task.

12. A method of a system to provide requirements within a region as claimed in claim 10 wherein the demand content relates to products or services.

13. A method of a system to provide requirements within a region as claimed in claim 6 wherein the supply side and the demand side are able to communicate with each other immediately through voice, text or video communications.

14. A method of a system to provide requirements within a region as claimed in claim 13 wherein the supply side and/or the demand side, each of whom stays outside a default distance from the other one during real-time communications, will be asked for continuing the communications.
